(19) United States
(12) Patent Application Publication
(10) Pub. No.: US 2026/0323622 A1
(43) Pub. Date: Oct. 15, 2026

(54) APPARATUS AND METHOD FOR SCHEDULING RESOURCES

(71) Applicant: Nokia Solutions and Networks Oy, Espoo (FI)

(72) Inventors: Thomas DEISS, Ulm (DE); Wolfgang Ulrich AICHMANN, Ulm (DE); Andre GILLE, Ulm (DE)

(21) Appl. No.: 19/645,900

(22) Filed: Apr. 13, 2026

(30) Foreign Application Priority Data
Apr. 15, 2025 (FI) 20253132

(51) Int. Cl. H04W 72/12; H04W 72/044; H04W 72/0453; H04W 72/543

(52) U.S. Cl. CPC H04W 72/12; H04W 72/0453; H04W 72/046; H04W 72/543

(57) ABSTRACT

An apparatus comprising at least one processor, and at least one memory storing instructions that, when executed by the at least one processor, cause the apparatus to: schedule first resources for a first network device, the first resources for the first network device being different from resources scheduled for at least a second network device, schedule second resources for the first network device, the second resources for the first network device at least partly overlapping with the resources scheduled for the second network device.

### FIELD OF THE DISCLOSURE

Various example embodiments relate to an apparatus for scheduling resources.

Further example embodiments relate to a method for scheduling resources.

### BACKGROUND

In wireless communication systems, resource scheduling is employed to manage and coordinate the allocation of resources among different entities, ensuring controlled and efficient access to the resources, including, for example, available spectrum.

### SUMMARY

Various example embodiments of the disclosure are set out by the independent claims. The example embodiments and features, if any, described in this specification, that do not fall under the scope of the independent claims, are to be interpreted as examples useful for understanding various example embodiments of the disclosure.

Some examples relate to an apparatus comprising at least one processor, and at least one memory storing instructions that, when executed by the at least one processor, cause the apparatus to: schedule first resources for a first network device, the first resources for the first network device being different from (e.g., not overlapping with) resources scheduled for at least a second network device, schedule second resources for the first network device, the second resources for the first network device at least partly overlapping with the resources scheduled for the second network device. In some examples, this enables to schedule different resources that may potentially be used by the first network device, wherein at least a part of these different resources, for example the second resources, may potentially be used by another, e.g., the second network device, e.g., if the first network device does not require the second resources. In some examples, the approach according to the disclosure may increase an efficiency regarding resource usage.

In some examples, at least one of the first network device or the second network device may adhere to and/or may be based on some accepted (and/or planned) specification, e.g., standard, such as, e.g., 3G, 4G, 5G, 6G, or some other wireless communication standard.

In some examples, the resources may comprise time and/or frequency resources, as may, e.g., be characterized by resource blocks, e.g., physical resource blocks. In some other examples, one or more further aspects, e.g., dimensions, of resources, may also be considered, such as, e.g., at least one spatial dimension.

In some examples, at least a first part of the first resources for the first network device is for exclusive use by the first network device (e.g., cannot be used by any other network device such as, e.g., the second network device), wherein at least a second part of the first resources for the first network device is for non-exclusive use by the first network device, e.g., may eventually be used by the second network device.

In some examples, the instructions, when executed by the at least one processor, cause the apparatus to: determine whether the first resources for the first network device are sufficient for at least one future information exchange associated with the first network device, and, if the first resources for the first network device are not sufficient for the at least one future information exchange associated with the first network device, allocate at least a part of the second resources to the first network device. In some examples, this may enable to ensure that sufficient resources are available for the at least one future information exchange associated with the first network device.

In some examples, the principle according to the disclosure enables efficient handling of even sporadic and bursty traffic.

In some examples, the instructions, when executed by the at least one processor, cause the apparatus to perform at least one of: a) signal that the first network device does not use the second resources, or b) signal that the first network device uses or will use the second resources. In some examples, any of this signaling may, e.g., be provided to at least one further device or entity, such as, e.g., a scheduler for the second network device. In some examples, the signaling may enable to notify the at least one further device or entity on whether the first network device uses or intends to use the second resources, which may cause a potential conflict for the second network device. Upon receiving the signaling according to the disclosure, the second network device may perform a conflict resolution, e.g., by adapting its own scheduling or resource allocation.

In some examples, the instructions, when executed by the at least one processor, cause the apparatus to perform at least one of: a) receive signaling indicating that the second network device does not use the first resources, or b) receive signaling indicating that the second network device uses or will use at least a specific portion of the first resources. In other words, in some examples, the second network device may also be configured to perform aspects according to the disclosure, wherein at least some of the resources for the first network device may, e.g., also, be scheduled for the second network device, e.g., in the sense of second resources for the second network device, e.g., similar to the second resources for the first network device.

In some examples, the instructions, when executed by the at least one processor, cause the apparatus to: when the received signaling indicates that the second network device uses or will use at least the specific portion of the first resources (e.g., in the sense of second resources for the second network device, as seen from the second network device), perform at least one of a) conflict detection, or b) conflict resolution associated with the specific portion of the first resources. In some examples, this may enable the first network device to resolve or avoid potential resource conflicts with the second network device.

In some examples, the second resources for the first network device comprise at least one of: a) a plurality of second resources, wherein different ones of the plurality of second resources are associated with different bandwidth parts, or b) a plurality of second resources, wherein different ones of the plurality of second resources are associated with different quality of service, QoS, classes, respectively.

In some examples, the second resources for the first network device comprise at least one of: a) frequency resources, or b) resources associated with a spatial domain (e.g., different beams), as, e.g., used for beam forming.

In some examples, the first network device is a first distributed unit (e.g., “DU”), wherein the second network device is a second distributed unit, e.g., of a same of different radio access technology.

In some examples, the first network device is associated with a first radio access technology (e.g., “RAT”), wherein the second device is associated with a second radio access technology which is different from the first radio access technology. As an example, the first RAT may, e.g., be associated with 3GG 5G NR, whereas the second RAT may, e.g., be associated with 6G.

In some other examples, however, the first and second RAT may be identical.

Some examples relate to an apparatus comprising means for: scheduling first resources for a first network device, the first resources for the first network device being different from resources scheduled for at least a second network device, scheduling second resources for the first network device, the second resources for the first network device at least partly overlapping with the resources scheduled for the second network device.

In some examples, the means for scheduling the first and second resources may, e.g., comprise at least one processor, and at least one memory storing instructions that, when executed by the at least one processor, cause the apparatus to perform the abovementioned aspects of scheduling the first and second resources.

In some examples, the means may, e.g., comprise circuitry configured to perform at least one of the aforementioned aspects of scheduling the first and second resources.

Some examples relate to a method for scheduling, comprising: scheduling first resources for a first network device, the first resources for the first network device being different from resources scheduled for at least a second network device, scheduling second resources for the first network device, the second resources for the first network device at least partly overlapping with the resources scheduled for the second network device.

Some examples relate to a scheduler device for a wireless communication network, comprising at least one apparatus according to the disclosure.

Some examples relate to a computer program comprising instructions which, when executed by an apparatus, cause the apparatus to perform the method according to the disclosure.

Some examples relate to a computer readable storage medium, for example a non-transient storage medium, comprising the computer program according to the disclosure.

Some examples relate to a data carrier signal carrying and/or characterizing the computer program according to the disclosure.

### BRIEF DESCRIPTION OF THE FIGURES

FIG. 1A schematically depicts a simplified block diagram,

FIG. 1B schematically depicts a simplified block diagram,

FIG. 2 schematically depicts a simplified block diagram,

FIG. 3 schematically depicts a simplified flow-chart,

FIG. 4 schematically depicts a simplified flow-chart,

FIG. 5 schematically depicts a simplified flow-chart,

FIG. 6 schematically depicts a simplified flow-chart,

FIG. 7 schematically depicts a simplified block diagram,

FIG. 8 schematically depicts aspects of resources,

FIG. 9 schematically depicts aspects of resources,

FIG. 10 schematically depicts a simplified signaling diagram,

FIG. 11 schematically depicts aspects of resources,

FIG. 12 schematically depicts a simplified block diagram.

### DESCRIPTION OF SOME EXAMPLE EMBODIMENTS

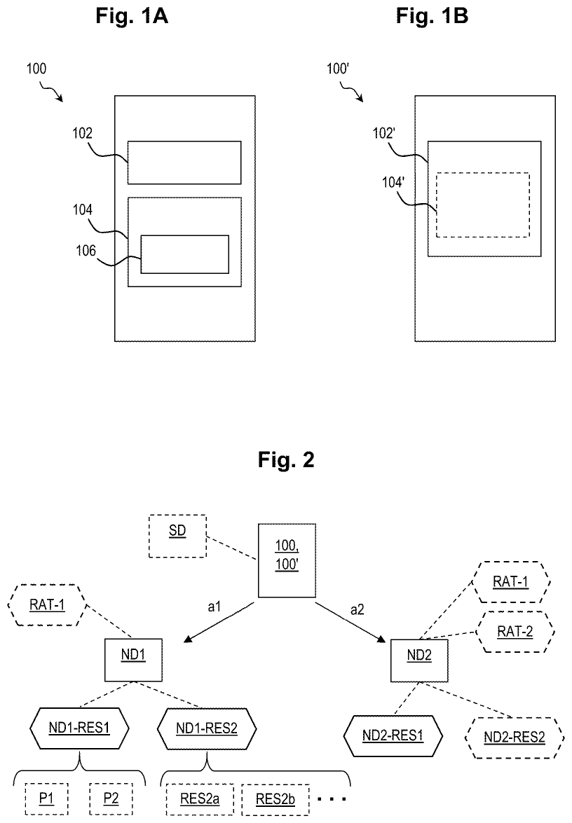

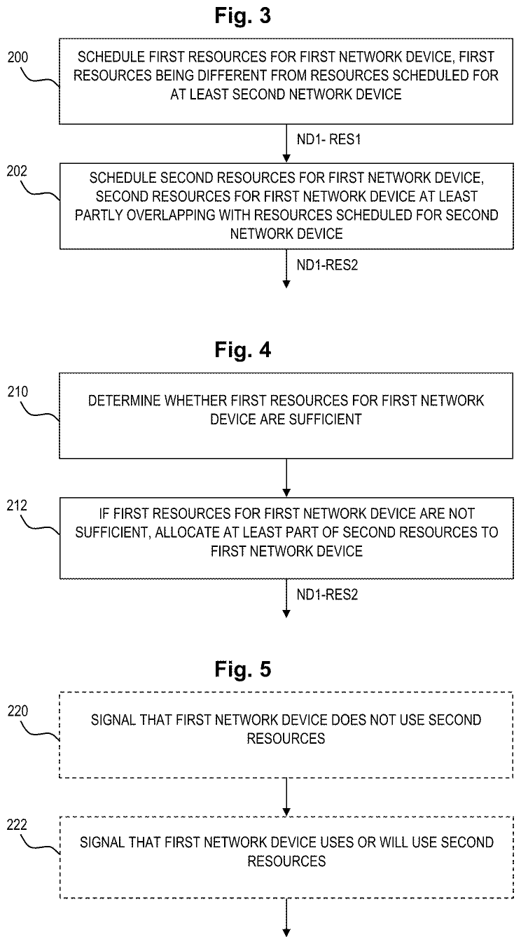

Some examples, see, for example, FIGS. 1A, 2, 3, relate to an apparatus 100 comprising at least one processor 102, and at least one memory 104 storing instructions 106 that, when executed by the at least one processor 102, cause the apparatus 100 to: schedule 200 (FIG. 3) first resources ND1-RES1 for a first network device ND1 (FIG. 2), the first resources ND1-RES1 for the first network device ND1 being different from (e.g., not overlapping with, e.g., within at least one resource dimension, such as, e.g., frequency) resources ND2-RES1 scheduled for at least a second network device ND2, schedule 202 (FIG. 3) second resources ND1-RES2 for the first network device ND1, the second resources ND1-RES2 for the first network device ND1 at least partly overlapping with the resources ND2-RES1 scheduled for the second network device ND2. In some examples, this enables to schedule, for the first network device ND1, different resources ND1-RES1, ND1-RES2 that may potentially be used by the first network device ND1, wherein at least a part of these different resources, for example the second resources ND1-RES2, may potentially be used by another, e.g., the second network device ND2, e.g., if the first network device ND1 does not require the second resources ND1-RES2. In some examples, the approach according to the disclosure may increase an efficiency regarding resource usage.

In some examples, FIG. 2, at least one of the first network device ND1 or the second network device ND2 may adhere to and/or may be based on some accepted (and/or planned) specification, e.g., standard, such as, e.g., 3G, 4G, 5G, 6G, or some other wireless communication standard.

In some examples, FIG. 2, at least a first part P1 of the first resources ND1-RES1 for the first network device is for exclusive use by the first network device ND1 (e.g., cannot be used by any other network device such as, e.g., the second network device ND2), wherein at least a second part P2 of the first resources ND1-RES1 for the first network device ND1 is for non-exclusive use by the first network device ND1, e.g., may eventually be used by the second network device ND2.

In some examples, FIG. 4, the instructions 106, when executed by the at least one processor 102, cause the apparatus 100 to: determine 210 whether the first resources ND1-RES1 for the first network device ND1 are sufficient for at least one future information exchange associated with the first network device, and, if the first resources ND1-RES1 for the first network device are not sufficient for the at least one future information exchange associated with the first network device, allocate 212 at least a part of the second resources ND1-RES2 to the first network device ND1. In some examples, this may enable to ensure that sufficient resources are available for the at least one future information exchange associated with the first network device ND1.

In some examples, the principle according to the disclosure enables efficient handling of even sporadic and bursty traffic.

In some examples, FIG. 5, the instructions 106, when executed by the at least one processor 102, cause the apparatus 100 to perform at least one of: a) signal 220 (e.g., to at least one further device, e.g., scheduler) that the first network device ND1 does not use the second resources ND1-RES2, or b) signal 222 (e.g., to at least one further device, e.g., scheduler) that the first network device uses or will use the second resources, or at least a part thereof. In some examples, any of this signaling 220, 222 may, e.g., be provided to at least one further device or entity, such as, e.g., a scheduler (not shown) for the second network device. In some examples, the signaling 220, 222 may enable to notify the at least one further device or entity on whether the first network device ND1 uses or intends to use the second resources ND1-RES2, which may cause a potential conflict for the second network device ND2. Upon receiving the signaling 220, 222 according to the examples, the second network device ND2 may perform a conflict resolution, e.g., by adapting its own scheduling or resource allocation.

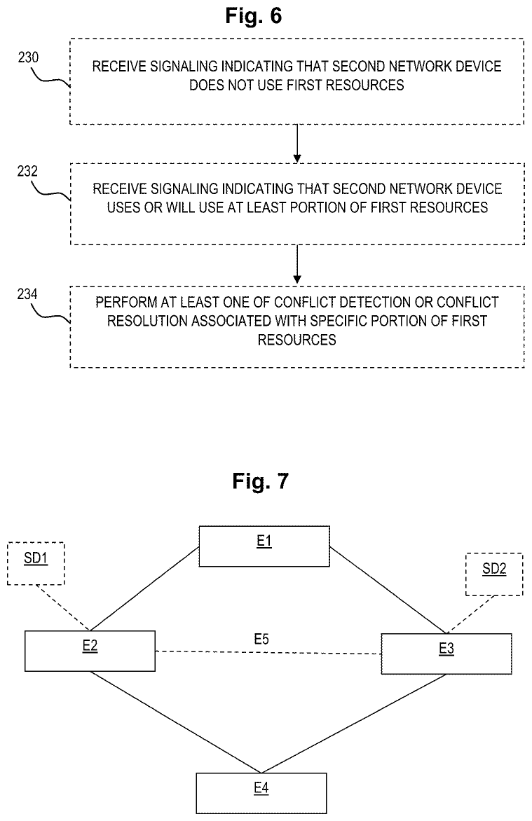

In some examples, FIG. 6, the instructions 106, when executed by the at least one processor 102, cause the apparatus 100 to perform at least one of: a) receive 230 (e.g., from at least one further device, e.g., scheduler) signaling indicating that the second network device ND2 does not use the first resources ND1-RES1 (e.g., similar to the signaling 220 of FIG. 5, for the first network device ND1), or b) receive 232 (FIG. 6, e.g., from at least one further device, e.g., scheduler) signaling indicating that the second network device ND2 uses or will use at least a specific portion of the first resources ND1-RES1 (e.g., similar to the signaling 222 of FIG. 5, for the first network device ND1). In other words, in some examples, the second network device ND2 may also be configured to perform aspects according to the disclosure, wherein at least some of the resources ND1-RES1 for the first network device ND1 may, e.g., also, be scheduled for the second network device ND2, e.g., in the sense of second resources ND2-RES2 (FIG. 2) for the second network device, e.g., similar to the second resources ND1-RES2 for the first network device ND1.

In some examples, FIG. 6, the instructions 106, when executed by the at least one processor 102, cause the apparatus 100 to: when the received signaling 232 indicates that the second network device uses or will use at least the specific portion of the first resources (e.g., in the sense of second resources ND2-RES2 for the second network device ND2, as seen from the second network device ND2), perform 234 at least one of a) conflict detection, or b) conflict resolution associated with the specific portion of the first resources. In some examples, this may enable the first network device ND1 to resolve or avoid potential resource conflicts with the second network device ND2.

In some examples, FIG. 2, the second resources ND1-RES2 for the first network device ND1 comprise at least one of: a) a plurality of second resources RES2a, RES2b, . . . , wherein different ones of the plurality of second resources RES2a, RES2b, . . . are associated with different bandwidth parts, or b) a plurality of second resources, wherein different ones of the plurality of second resources RES2a, RES2b, . . . are associated with different quality of service, QoS, classes, respectively.

In some examples, FIG. 2, the second resources ND1-RES2 for the first network device ND1 comprise at least one of: a) frequency resources, or b) resources associated with a spatial domain, as, e.g., used for beam forming.

In some examples, FIG. 2, the first network device ND1 is a first distributed unit (e.g., “DU”), wherein the second network device ND2 is a second distributed unit.

In some examples, FIG. 2, the first network device ND1 is associated with a first radio access technology (e.g., “RAT”) RAT-1, wherein the second network device ND2 is associated with a second radio access technology RAT-2 which is different from the first radio access technology rat-1. As an example, the first radio access technology RAT-1 may, e.g., be associated with 3GPP 5G NR, whereas the second radio access technology RAT-2 may, e.g., be associated with 6G.

In some other examples, however, the first radio access technology RAT-1 and the second radio access technology RAT-2 may be identical.

Some examples, FIG. 1B, relate to an apparatus 100′ comprising means 102′ for: scheduling 200 (FIG. 3) first resources for a first network device, the first resources for the first network device being different from resources scheduled for at least a second network device, scheduling 202 second resources for the first network device, the second resources for the first network device at least partly overlapping with the resources scheduled for the second network device.

In some examples, FIG. 1B, the means 102′ for scheduling 200, 202 the first and second resources may, e.g., comprise at least one processor 102 (see, for example, FIG. 1A), and at least one memory 104 storing instructions 106 that, when executed by the at least one processor 102, cause the apparatus 100′ to perform the abovementioned aspects of scheduling 200, 202 the first and second resources.

In some examples, FIG. 1B, the means 102′ may, e.g., comprise circuitry 104′ configured to perform at least one of the aforementioned aspects of scheduling 200, 202 the first and second resources.

Some examples, FIG. 3, relate to a method for scheduling, comprising: scheduling 200 first resources for a first network device, the first resources for the first network device being different from resources scheduled for at least a second network device, scheduling 202 second resources for the first network device, the second resources for the first network device at least partly overlapping with the resources scheduled for the second network device.

Some examples, FIG. 2, relate to a scheduler device SD for a wireless communication network, comprising at least one apparatus 100, 100′ according to the disclosure. In some examples, the scheduler device SD may, e.g., at least temporarily, perform aspects of scheduling for at least one of the network devices ND1, ND2, also see the arrows a1, a2.

In the following, further aspects and examples are disclosed, which, in some examples, may be combined with each other and/or with at least one of the aforementioned aspects or examples.

In some examples, FIG. 7, the principle of the disclosure may be used for Multi-RAT Spectrum Sharing, e.g., “MRSS”, for example Multi-Vendor MRSS, e.g., “MV-MRSS”, wherein separate schedulers or scheduler devices SD1, SD2, respectively, may be provided, e.g., for, e.g., in, RAT-specific DUs. In this regard, element E1 of FIG. 7 symbolizes a Multi-RAT Resource Manager, “MRMM”, according to some examples. Element E2 symbolizes a first network device, e.g., at least similar to element ND1 of FIG. 2, wherein for example element E2 represents a DU for a first RAT, e.g., 5G NR, e.g., a NR DU. Element E3 symbolizes a second network device, e.g., at least similar to element ND2 of FIG. 2, wherein for example element E3 represents a DU for a second RAT, e.g., 6G, e.g., a 6G DU. Element E4 symbolizes a, for example common, radio unit, e.g., “RU”. Element E5 symbolizes an optional information exchange between the first DU E2 and the second DU E3.

In some examples, FIG. 7, the scheduler devices SD1, SD2 may communicate, e.g., directly or indirectly, e.g., via a resource management entity represented by the MRRM E1.

In some conventional approaches related to MRRM and different DUs, due to architectural limits, e.g. caused by communication latencies and message processing time, it may be impossible for different schedulers to coordinate their scheduling within a predetermined time, e.g., per slot. Instead, in some conventional approaches, resources may be allocated for a specific period by the conventional MRRM to the conventional DUs.

In at least some conventional approaches, a DU is bound to its allocated resources within an allocation period. Nevertheless, there may be abrupt changes of a traffic load within a specific allocation period, and it would be beneficial if the DUs could react to such change. The faster the reaction, the lower the latency experienced by the respective bearers.

A further use case with similar issue for sharing resources of one carrier, as may be found in some conventional approaches, occurs if one RU is shared between DUs of a same RAT and the DUs have to allocate resources of a single RAT carrier among them. While the further explanation in the following is along the lines of MRSS, for simplicity, the principle of the disclosure may be equally applied at least to the both cases explained above, e.g., to MRSS as well as to resource sharing associated with a single RAT.

In some examples, the principle of the disclosure enables to reduce, e.g., minimize a reaction time, e.g., to abrupt traffic changes, e.g., to be within one slot duration.

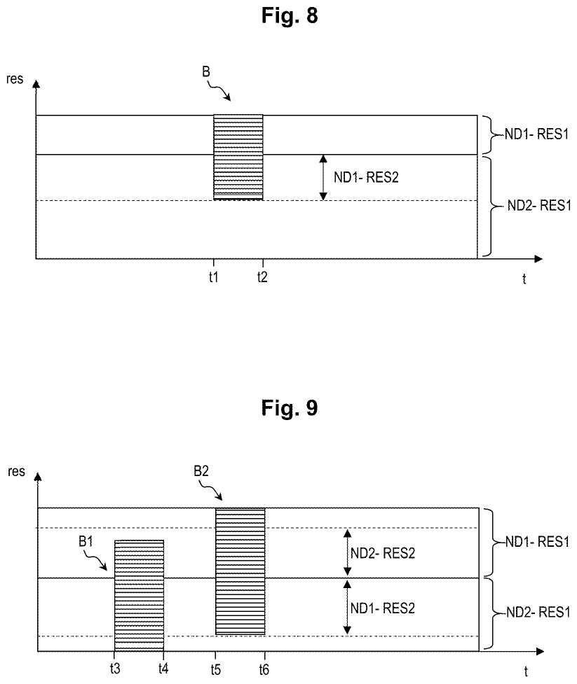

In the following, example traffic scenarios are discussed with reference to FIGS. 8, 9, which illustrate aspects of the disclosure, depicting an amount of resources res over a horizontal time axis t.

In some examples, FIG. 8, it may be assumed that a first radio access technology RAT-1 (also see FIG. 2) is comparatively lowly loaded, and a second radio access technology RAT-2 is comparatively highly loaded. In such case, comparatively few (or even zero) resources may be allocated to the first RAT, see the first resources ND1-RES1 for the first network device ND1, which is associated with the first RAT RAT-1, as depicted by FIG. 8. However, in such cases, comparatively many resources may be allocated to the second RAT, see the first resources ND2-RES1 for the second network device ND2, which is associated with the second RAT RAT-2, as depicted by FIG. 8, and these comparatively many resources may, e.g., actually be used by the second network device ND2.

In some examples, FIG. 8, however, still, it should be possible for the first network device to transmit, e.g., sporadic bursts B of traffic within a considered allocation period, see the dashed rectangle between time t1 and time t2. In some examples, the traffic burst B of the comparatively lowly-loaded RAT RAT-1 may temporarily exceed an original allocation, e.g., to reduce an end-to-end (e.g., “e2e”) latency. The faster the first RAT can use additional resources ND1-RES2 to accommodate, e.g., transmit, the burst B, the lower the e2e latency. In some examples, for transmitting the burst B, the first network device ND1 may use the second resources ND1-RES2, e.g., additionally to the first resources ND1-RES1, which has the effect that the second resources ND1-RES2 may not be used by the second network device, to avoid a respective resource conflict. In some examples, otherwise, e.g., if there is no burst B, the first network device ND1 does not require to use the second resources ND1-RES2, so that these second resources ND1-RES2 may be used by the second network device ND2.

FIG. 9 schematically depicts a resource situation wherein both RATs RAT-1, RAT-2 (also see FIG. 2) are comparatively lowly or equally loaded, with sporadic bursty traffic, see the bursts B1, B2. In such cases, in some examples, it can be assumed that resources res are allocated equally to both RATs RAT-1, RAT-2 or the network devices ND1, ND2, respectively.

As an example, FIG. 9, in case of a traffic burst B1, B2 for one network device, e.g., DU, in some examples it is possible to use more than the originally scheduled first resources, e.g., all resources, by, e.g., for, one RAT.

More specifically, in some examples, FIG. 9, while the first resources ND2-RES1 for the second network device ND2 may not be sufficient to transmit the burst B1 within time interval t3, t4, in some example, second resources ND2-RES2 according to the principle of the disclosure may have been scheduled for the second network device, these second resources ND2-RES2 enabling the second network device ND2 to transmit the burst B1 within the time interval t3, t4, thus, e.g., enabling to minimize an e2e latency. In other words, according to the principle of the disclosure, the second network device ND2 may at least temporarily use more than the allocated first resources ND2-RES1 for the second network device, namely at least a part of the allocated second resources ND2-RES2 for the second network device ND2, e.g., as quickly as possible, e.g., to minimize the e2e latency with respect to transmission of the burst B1.

Similarly, in some examples, FIG. 9, while the first resources ND1-RES1 for the first network device ND1 may not be sufficient to transmit the burst B2 within time interval t5, t6, in some example, second resources ND1-RES2 according to the principle of the disclosure may have been scheduled for the first network device, these second resources ND1-RES2 enabling the first network device ND1 to transmit the burst B2 within the time interval t5, t6, thus, e.g., enabling to minimize an e2e latency. In other words, according to the principle of the disclosure, the first network device ND1 may at least temporarily use more than the allocated first resources ND1-RES1 for the first network device, namely the allocated second resources ND1-RES2 for the first network device ND2, e.g., as quickly as possible, e.g., to minimize the e2e latency with respect to transmission of the burst B2.

In other words, in some examples, FIG. 7, e.g., in addition to a usual, e.g., conventional, resource allocation, the MRRM E1 may allocate further resources to each network device E2, E3, e.g., in the form of the second resources ND1-RES2, ND2-RES2.

Note that, while the resource distribution of the examples of FIGS. 8, 9 is comparatively simple, the principle of the disclosure may, without loss of generality, also be applied to more complex resource distributions.

In some examples, one RAT or the associated network device may be considered as a host of the second resources, and the other RAT or the associated network device may be considered as a guest with respect to the second resources. In some examples, it may be provided that the second resources ND1-RES2, ND2-RES2 do not overlap mutually, but may, e.g., overlap with other resource allocations, e.g., in the form of the first resources ND1-RES1, ND2-RES1.

In some examples, FIG. 7, scheduler devices SD1, SD2, e.g., packet schedulers (e.g., “PS”), of both RATs may use the second resources ND1-RES2, ND2-RES2. In some examples, e.g., if a host of second resources ND1-RES2 uses the second resources ND1-RES2 (e.g., for accommodating the burst B2 within time interval t4, t5 of FIG. 9), the host may indicate this to the guest of the respective second resources ND1-RES2, also see block 222 of FIG. 5. In some examples, when the guest receives such an indication or signaling 222, e.g., when scheduling resources for the same time interval, e.g., slot, the guest might have assigned these resources, e.g., to some terminal devices, e.g., UE, (not shown) already. In such cases, in some examples, the guest may discard its resource assignments or may modify them in a way such that they do not conflict with usage of the second resources ND1-RES2 by the host ND1, also see block 234 of FIG. 6. I.e., in some examples, the host ND1 may have priority in resource usage. In some examples, no acknowledgement related to the signaling 222 is used, e.g., needed, thus, e.g., reducing a messaging overhead.

In some examples, aspects of the disclosure may be used together with a HARQ (hybrid automatic repeat request) procedure, wherein, for example, a discarded transmission does not cause a retransmission, and wherein, for example, a UE may be scheduled again, e.g., on a next slot, e.g., for an initial transmission.

In some examples, the principle according to the disclosure enables network devices ND1, ND2, such as, e.g., DU, to react, e.g., instantaneously, to, e.g., abrupt, changes in a traffic load (see, for example, the bursts B, B1, B2 of FIGS. 8, 9), thus, e.g., reducing an e2e latency and increasing instantaneous UE throughput. In some examples, the principle according to the disclosure is applicable in cases of communication latency between DU smaller than slot duration.

In some examples, FIG. 7, second resources ND1-RES2, ND2-RES2 may be allocated, e.g., by the MRRM E1, e.g., to one or both RATs RAT-1, RAT-2 (FIG. 2). Continuing the abovementioned example with a comparatively highly loaded first RAT and a comparatively lowly loaded second RAT, see, for example, FIG. 8, in some examples, second resources may be declared and used as as follows. The first RAT, e.g., associated with the first network device ND1, may comprise comparatively few first resources ND1-RES1 which are, for example, allocated regularly, but the first RAT and/or the first network device ND1 may have additional second resources ND1-RES2 scheduled according to the principle of the disclosure, see, for example, block 202 of FIG. 3. Thus, the first RAT or network device ND1 may use these resources ND1-RES1 and, additionally, ND1-RES2, e.g., when needed (see, for example, the burst B of FIG. 8), and otherwise, the second RAT or the second network device ND2 may use the second resources ND1-RES2.

In some examples, the resource diagram of FIG. 9 may be used to describe aspects of a use of resources, e.g., for two comparatively lowly (or equally) loaded network devices ND1, ND2 or associated radio cells, respectively, wherein respective second resources ND1-RES2, ND2-RES2 may be used to transmit bursts B1, B2, as already explained above.

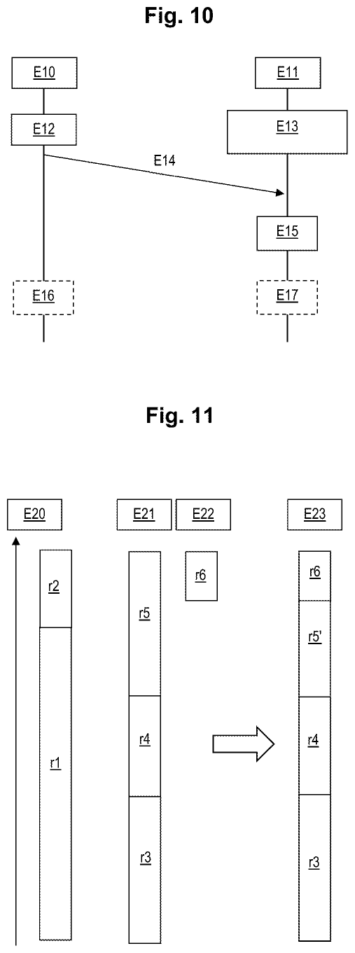

An example behavior of two schedulers E10, E11 (e.g., at least similar to the elements SD1, SD2 of FIG. 7) according to some examples is illustrated in FIG. 10. In some examples, resource assignments, e.g., to UE, are done in two steps: firstly, there is an actual resource assignment, see blocks E12, E13, and secondly, there is some optional postprocessing, e.g. bookkeeping, see blocks E16, E17.

In some examples, FIG. 10, both schedulers E10, E11 may have assigned resources using the second resources of the host, which, in some examples, is associated with the scheduler E10. In some examples, the scheduler E10 sends a corresponding indication E14 (also see, for example, the block 222 of FIG. 5) to the guest or its associated scheduler E11, respectively. The scheduler E11 of the guest may resolve a potential conflict, see block E15, e.g., by discarding or modifying its resource assignment E13 or by using an alternative scheduling, e.g., based on the indication E14.

In some examples, FIG. 10, the scheduler E11 of the guest may have prepared an alternative scheduling, e.g., scheduling another UE outside of this area, or it may even calculate an alternative resource assignment when it receives the scheduling indication E14 from the scheduler E10 of the host. In some examples, to prepare such alternative schedulings, the DU representing the guest may, e.g., use knowledge about which resources are second resources, e.g., as seen from the DU representing the host. In other words, in some examples, at least one of the scheduler E11 or an apparatus 100, 100′ according to the disclosure may perform at least one of the following aspects: a) preparing at least one alternative scheduling, or b) determining, e.g., calculating, at least one alternative resource assignment, for example in response to receiving a scheduling indication according to the disclosure, see, for example, element E14, or c) reducing resources assigned to at least one device, e.g., terminal device, e.g., UE.

In this regard, FIG. 11 schematically depicts example resource assignments and their resolution, as may be used for dealing with potential resource conflicts according to some examples. In the diagram of FIG. 11, element E20 and the associated arrow symbolizes resources, e.g., in the form of physical resource blocks, e.g., “PRB”, wherein element r1 symbolizes first resources associated with a first RAT such as, e.g., 5G NR, wherein element r2 symbolizes second resources associated with a second RAT such as, e.g., 6G.

Element E21 symbolizes aspects of scheduling associated with the first RAT, e.g., 5G NR, e.g., an NR scheduler, wherein element r3 represents scheduled resources of 5G NR for a first terminal device, e.g., “UE1”, wherein element r4 represents scheduled resources of 5G NR for a second terminal device, e.g., “UE2”, wherein element r5 represents scheduled resources of 5G NR for a third terminal device, e.g., “UE3”.

Element E22 symbolizes aspects of scheduling associated with the second RAT, e.g., 6G, e.g., a 6G scheduler, wherein element r6 represents scheduled 6G resources for the first terminal device UE1.

In some examples, FIGS. 11, 6G resources may be seen as second resources, wherein 5G NR may be seen as a host.

In some examples, FIG. 11, most of the resources may be allocated, e.g., as first resources, exclusively to NR, see element r1, wherein some resources may be allocated, e.g., as second resources, to 6G, see element r2. In some examples, the NR scheduler E21 may assign all resources, e.g., including the second resources, to its UE UE1, UE2, UE3m see elements r3, r4, r5. In some examples, e.g., if there is no scheduling indication (see, for example, element E14 of FIG. 10) from the 6G DU as host, all PRBs as resources, e.g., on a specific slot, may be used for the NR UE. If, in some examples, the 6G scheduler E22 assigns some or all of the second resources to 6G UE, see element r6, the 6G scheduler E22 may indicate this to the NR scheduler E21, e.g., using an indication E14 of FIG. 10, also see block 222 of FIG. 5.

In some examples according to FIG. 11, the NR scheduler E21 may, e.g., reduce, based on the indication of the 6G scheduler E22, resources for NR UE3, e.g., such that there is no longer a conflict, see element E23 symbolizing combined aspects of 5G NR and 6G scheduling, wherein the NR resources r3, r4 are unchanged, wherein r5′ symbolizes the reduced resources for NR UE3, and wherein r6 symbolizes the 6G resources that may now be accommodated by the considered resources because the resources r5′ have been reduced as explained above.

In some examples, e.g., to be prepared for such change, the NR scheduler E21 may allocate all resources of the second resources r2 to a single UE, e.g., NR UE3, which enables to resolve the conflict by simply modifying the resource assignment to this single NR UE3.

In some examples, FIG. 7, e.g., in case of a scenario as in FIG. 8 related to asymmetrically loaded RATs, the MRRM E1 (FIG. 7) may configure second resources ND1-RES2 for the lowly loaded RAT. In some examples, there may be no benefit for configuring second resources for the highly loaded RAT. In such asymmetric configuration, in some examples, the lowly loaded RAT can be expected to finish a first stage of its scheduling comparatively early, thus, e.g., giving sufficient time to transmit a scheduling indication, see, for example element E14 of FIG. 10, to the scheduler of the comparatively highly loaded RAT.

In some examples, FIGS. 7, 9, e.g., in case of a scenario as in FIG. 9, related to at least substantially symmetrically loaded RATs, the MRRM E1 may configure second resources ND1-RES2, ND2-RES2 for both RATs. This allows both RATs or their network devices ND1, ND2, respectively, to use all available resources, e.g., instantaneously. In case traffic bursts of both RATs coincide (not shown), in some examples, both RATs may have to give up reserved resources it used as a guest.

In the previous explanations, for the sake of simplicity, but without loss of generality, a single set of second resources was used, but, in some examples, a plurality of second resources may also be used, e.g., defined, e.g., one per bandwidth part and/or one per QoS class, also see elements RES2a, RES2b, . . . of FIG. 2.

In some examples, e.g., to increase robustness of the proposed scheme, the host ND1 (FIG. 2) of a second resource may send a scheduling indication, for example repeatedly, for example periodically, for example in each slot, thus, e.g., potentially indicating that no UE was scheduled. In some examples, a guest UE may interpret a lack or a delayed reception of a scheduling indication as a conflict and may, e.g., trigger one or more actions, e.g., to resolve the conflict. Note that, in some examples, if no UE is scheduled on a slot, the first scheduling stage (see, e.g., block E12 of FIG. 10) may end earlier and more time may be available, e.g., for transmitting a scheduling indication E14 to another network device ND2 or its scheduler E11, respectively.

In some examples, the concept of the second resources ND1-RES2, ND2-RES2 according to the disclosure may be interpreted as a specific case of a more general scheme: In general, in some examples, there may be overlapping resource assignments to at least two network devices ND1, ND2, e.g., DUs, wherein the DUs may, in some examples, inform each other, e.g., after their first scheduling stage, and in some examples, the DUs may, e.g., resolve potential conflicts, e.g., based on agreed priorities. In some examples, such priority may, e.g., correspond to at least one of: a) a traffic priority of one or more UE, or b) alternating priorities per slot, etc. When using the second resources according to the disclosure, the potentially overlapping area of the resources is not arbitrary, but is restricted to the second resources themselves, and in some examples, the priority for conflict resolution may be “host prioritized over guest”. In some examples, knowing the potential overlap of first and second resources may ease it for at least some schedulers to prepare alternative resource assignments.

In some examples, the principle of the disclosure may be used for assigning resources for PDSCH (Physical Downlink Shared Channel) and/or PUSCH (Physical Uplink Shared Channel). In some examples, the principle of the disclosure may be applied to PDCCH (Physical Downlink Control Channel), e.g., on a same set of CCEs (control channel elements) as well, e.g. sharing a first symbol of a slot for PDCCH of both RATs RAT-1, RAT-2. In some examples, conflicts may be resolved by either discarding a scheduling of a UE or finding alternative CCEs for a UE. In some examples, a priority may correspond to a traffic priority of the respective UE, or simply alternating, e.g., per slot.

In some examples, the principle of the disclosure may also be used for beam forming, where transmission into a spatial area of a cell may, e.g., add another dimension to a resource grid. In these examples, second resources, e.g., on a slot, may represent a combination of resources in the frequency domain and the spatial domain.

In some examples, e.g., in case of sharing one radio unit (RU), e.g., among several DUs of a same RAT, the principle according to the disclosure is applicable to two or more DUs. In some examples with more than two DUs, second resources may, e.g., be defined pairwise, e.g., among the DUs. In other words, each second resource may still have one host DU and one guest DU, such that, e.g., an amount of messaging may be reduced and conflicting usage of a resource by several guests may be avoided.

In some examples, one or more aspects of the disclosure may be used to extend at least some conventional wireless communication systems.

In some examples, one or more aspects of the disclosure may be standardized, e.g., as part of a 3GPP MV-MRSS solution. In some examples, one or more aspects of the disclosure may be standardized, e.g., by ORAN (Open RAN (Radio Access Network)), e.g., for RU sharing by several DUs.

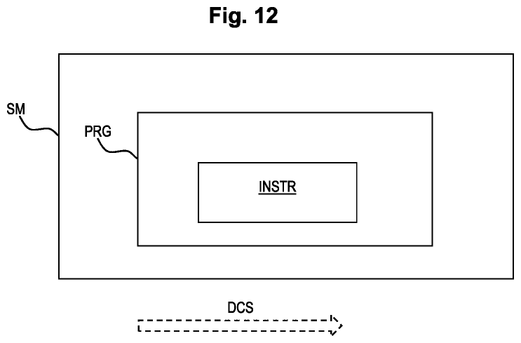

Some examples, FIG. 12, relate to a computer program PRG comprising instructions INSTR which, when executed by an apparatus 100, 100′, cause the apparatus 100, 100′ to perform the method according to the disclosure.

Some examples, FIG. 12, relate to a computer readable storage medium SM, for example a non-transient storage medium SM, comprising the computer program PRG according to the disclosure.

Some examples, FIG. 12, relate to a data carrier signal DCS carrying and/or characterizing the computer program PRG according to the disclosure.

1. An apparatus comprising at least one processor, and at least one memory storing instructions that, when executed by the at least one processor, cause the apparatus to: schedule first resources for a first network device, the first resources for the first network device being different from resources scheduled for at least a second network device, schedule second resources for the first network device, the second resources for the first network device at least partly overlapping with the resources scheduled for the second network device.

2. The apparatus according to claim 1, wherein at least a first part of the first resources for the first network device is for exclusive use by the first network device, and wherein at least a second part of the first resources for the first network device is for non-exclusive use by the first network device.

3. The apparatus according to claim 1, wherein the instructions, when executed by the at least one processor, cause the apparatus to: determine whether the first resources for the first network device are sufficient for at least one future information exchange associated with the first network device, and, if the first resources for the first network device are not sufficient for the at least one future information exchange associated with the first network device, allocate at least a part of the second resources to the first network device.

4. The apparatus according to claim 1, wherein the instructions, when executed by the at least one processor cause the apparatus to perform at least one of: signal that the first network device does not use the second resources, or signal that the first network device uses or will use the second resources.

5. The apparatus according to claim 1, wherein the instructions, when executed by the at least one processor, cause the apparatus to perform at least one of: receive signaling indicating that the second network device does not use the first resources or receive signaling indicating that the second network device uses or will use at least a specific portion of the first resources.

6. The apparatus according to claim 5, wherein the instructions, when executed by the at least one processor, cause the apparatus to: when the received signaling indicates that the second network device uses or will use at least the specific portion of the first resources, perform at least one of conflict detection, or conflict resolution associated with the specific portion of the first resources.

7. The apparatus according to claim 1, wherein the second resources for the first network device comprise at least one of: a plurality of second resources, wherein different ones of the plurality of second resources are associated with different bandwidth parts, or a plurality of second resources, wherein different ones of the plurality of second resources are associated with different quality of service, QoS, classes, respectively.

8. The apparatus according to claim 1, wherein the second resources for the first network device comprise at least one of: frequency resources, or resources associated with a spatial domain.

9. The apparatus according to claim 1, wherein the first network device (ND1) is a first distributed unit, wherein the second network device (ND2) is a second distributed unit.

10. The apparatus according to claim 1, wherein the first network device (ND1) is associated with a first radio access technology (RAT-1), wherein the second device (ND2) is associated with a second radio access technology (RAT-2) which is different from the first radio access technology (RAT-1).

11. (canceled)

12. A method for scheduling, comprising: scheduling first resources for a first network device, the first resources for the first network device being different from resources scheduled for at least a second network device, scheduling second resources for the first network device, the second resources for the first network device at least partly overlapping with the resources scheduled for the second network device.

13. A scheduler device for a wireless communication network, comprising at least one apparatus according to claim 1.

14. A computer program comprising instructions which, when executed by an apparatus, cause the apparatus to perform the method according to claim 12.

15. A computer readable storage medium, for example a non-transient storage medium, comprising the computer program according to claim 14.

16. A data carrier signal carrying and/or characterizing the computer program according to claim 14.
